(19) United States
(12) Patent Application Publication
(10) Pub. No.: US 2007/0010623 A1
(43) Pub. Date: Jan. 11, 2007

(54) Low-refractive index layer, AR coatings having such a layer and methods for producing them

(75) Inventor: Chau Thiminh Ha, Chicago, IL (US)

Correspondence Address: PEARNE & GORDON LLP, 1801 EAST 9TH STREET, SUITE 1200, CLEVELAND, OH, 44114-3108, US

(73) Assignee: Addison Clear Wave LLC

(21) Appl. No.: 11/175,728

(22) Filed: Jul. 6, 2005

(51) Int. Cl. C08F 8/00; C08L 27/00

(52) U.S. Cl. 525/129

(57) ABSTRACT

A low refractive index layer for anti-reflection film applications includes a fluorinated copolymer as the principal low refractive index material. The fluorinated copolymer is soluble in a non-halogenated organic solvent, enabling deposition of the low refractive index layer of uniform thickness onto conventional substrates via conventional wet coating processes, but without the need for or use of expensive and environmentally unfriendly halogenated solvents. Coating compositions for depositing such a low refractive index layer and methods of depositing them also are disclosed.

### BACKGROUND OF THE INVENTION

1. Field of the Invention

The invention relates to low-refractive index compositions useful in producing a low refractive index layer for anti-reflection films. More particularly, it relates to such layers that can be deposited via a wet-coating process without the use of halogenated solvents.

2. Description of Related Art

The digital electronics market is growing steadily and rapidly. Particularly rapid expansion is expected as the demand rises for components such as liquid crystal displays, plasma television displays, PC monitors, portable computer screens, PDAs and electronic games, as well as for large digital information display applications such as scoreboards and marquis, etc. All of these display technologies currently utilize or will benefit from the use of anti-refractive coatings disposed over or as part of the display surface effective to reduce glare and surface reflectance. Anti-refractive (AR) coatings are used to coat information displays including those noted in this paragraph to increase the transmission of visible light through the display surface or “window” by reducing surface reflectance losses and reducing multiple surface reflectances, thereby improving visible light transmittance and perceived image quality. They are also used to coat polarizing films inside the display unit to reduce internal reflected light.

Conventionally, AR coatings are composed at least in part of a series of alternating high- and low-refractive index layers as known in the art, whose overall effect is to phase shift a substantial portion of what otherwise would be reflected visible light from the coated surface such that the associated light waves are canceled out and the net total surface reflectance is substantially reduced. Thus, for example, whereas an untreated glass surface (lacking any AR coating) may have a total surface reflectance of visible light of 9% or greater, an AR coating on that same surface can reduce total surface reflectance of visible light to as low as or less than about 1%. Also, AR coatings significantly reduce multiple surface reflectances and surface scattering, thus greatly improving the overall transmittance through the display surface so the information beneath can be more readily perceived by the human observer. Also, low surface reflectance means lower display contrasts can be used without compromising the perception and visualization of displayed images, for example in multi-color displays. The result is that a broader range of colors and light intensities are made available for producing high quality images than would be possible absent some AR coating. This is particularly true in outdoor and daylight applications where natural sunlight otherwise could obscure images on even very brightly lit and high-contrast displays. Also, AR coatings on polarizers in the display units result in lower power consumption, which is important for portable battery-powered units.

There are two basic types of coating methods used to deposit the refractive layers of AR coatings onto a substrate surface, vacuum deposition and wet coating. Vacuum deposition methods are useful where the substrate surface includes intricate structure or where portions of the surface may be obscured or eclipsed, thus obstructing direct line-of-sight access to such portions. However, vacuum deposition is relatively cumbersome and expensive, and generally is not suitable for continuous steady-state application of refractive layers to a continuous or oversized web of substrate material because this technique must be carried out within a low-pressure vacuum chamber under tightly controlled conditions. Conversely, wet coating methods involve coating a substrate surface with a liquid anti-refractive coating composition in which non-volatile coating components are dissolved in a volatile solvent. After coating the substrate, the solvent is evaporated thus depositing the non-volatile components on the substrate surface. Wet coating methods generally are lower cost compared to vacuum deposition, and further are suitable for coating continuous or oversized material webs such as at steady-state.

A desirable low-refractive index layer of an AR coating will have both a low-refractive index (preferably less than about 1.45 at 589 nm measured at 25° C.) and, when applied by wet coating methods, high solvent and solute wettability to the coated substrate. (The wavelength 589 nm is that emitted from the well known sodium-D lamp, and is a standard comparator for visible light which ranges from about 400 to about 750 nm). Both fluorinated chemicals and silane materials can provide the low-refractive indices required for low refractive index layers. Up till now, primarily heat curable polysilane materials have been used for producing the low refractive index layers for AR coatings. However, these silicon-based materials exhibit several disadvantages including long curing time, high cure temperatures and poor wetting performance to underlying high-refractive index layers and to conventional substrate materials such as glass and PET. In particular, for refractive indices below 1.40 at 589 nm measured at 25° C., the production of polysilane materials having suitable wetting characteristics, transparency, low haze, etc. for mass production of AR coatings has proven difficult.

Furthermore, while fluorine-containing materials are known to exhibit suitably low refractive indices, e.g., 1.35 and 1.34 for polytetrafluoroethylene (PTFE) and polytetrafluoroethylene-hexafluoropropylene (PTFE-HPE) respectively, these polymers have low transparency and poor adhesion to substrates. In addition, and perhaps most detrimental to their widespread use as low refractive index materials for AR coatings is that conventional low refractive index fluoropolymers are insoluble in non-halogenated solvents. The halogenated solvents required to dissolve these materials so they can be used in a wet coating process present substantial health and environmental concerns due to the presence of the halogens, particularly chlorine, in the volatile solvents. In addition, the high cost of halogenated solvents makes their use prohibitively expensive in wet coating processes due to the fact that the solvent is evaporated off during the process and generally is lost.

Some producers have made considerable efforts to develop fluorinated curable resins for producing low refractive index layers for AR coating applications. However, a major disadvantage to this approach is the cost of the raw materials which is very high and thus limits their utility. Moreover, the wetting performances of such resins typically are poor, making them unsuitable for production processing.

There is a need in the art for a low refractive index layer that can be deposited by a wet coating process without the use of halogenated, particularly fluorinated and/or chlorinated, solvents, yet which exhibits suitable properties of refractive index, solute and solvent wetting to the coated substrate, and is substantially transparent.

### SUMMARY OF THE INVENTION

A composition is provided which includes a fluorinated copolymer of at least three different monomeric species, at least one of the monomeric species being a fluorinated species, wherein the fluorinated copolymer is soluble and dissolved in a non-halogenated organic solvent.

A low refractive index layer also is provided, having a fluorinated copolymer of at least three different species of monomeric units, wherein at least one of the species of monomeric units is a fluorinated species. The fluorinated copolymer is soluble in a non-halogenated organic solvent.

An information display structure also is provided. The structure includes a substantially transparent substrate having a surface and an anti-refractive coating on that surface. The anti-refractive coating includes a low refractive index layer having a fluorinated copolymer of at least three different species of monomeric units, wherein at least one of the species of monomeric units is a fluorinated species. The fluorinated copolymer is soluble in a non-halogenated organic solvent.

A further information display structure is provided, having a substantially transparent substrate having a surface and an anti-refractive coating on that surface, the anti-refractive coating including a first low refractive index layer and a second low refractive index layer located superjacent the first low refractive index layer and spaced therefrom by at least one high refractive index layer. The first low refractive index layer has a first fluorinated copolymer of at least three different species of monomeric units, at least one of the species of monomeric units being a fluorinated species, and the first fluorinated copolymer is soluble in a non-halogenated organic solvent. The second low refractive index layer has a second fluorinated copolymer of at least three different species of monomeric units, wherein at least one of the species of monomeric units is a fluorinated species, and the second fluorinated copolymer is soluble in a non-halogenated organic solvent. The first and second fluorinated copolymers are not necessarily the same.

A method for depositing a low refractive index layer also is provided, including the following steps: a) preparing or providing a non-volatile mixture including a fluorinated copolymer of at least three different species of monomeric units, wherein at least one of the species of monomeric units is a fluorinated species, the fluorinated copolymer being soluble in a non-halogenated solvent; b) dissolving the non-volatile mixture in a non-halogenated organic solvent to provide a coating composition; c) coating a substrate surface with the coating composition via a wet coating process; and d) permitting or causing the non-halogenated solvent to evaporate thereby depositing the non-volatile mixture onto the substrate surface.

### BRIEF DESCRIPTION OF THE DRAWINGS

FIG. 1 shows, schematically, a cross-section of a typical AR coating structure on a substrate surface.

FIG. 2 shows, schematically, a cross-section of an AR coating structure as in FIG. 1, but having a plurality of cooperating high- and low-refractive index layers.

### DETAILED DESCRIPTION OF PREFERRED EMBODIMENTS OF THE INVENTION

As used herein, when a range such as 5-25 (or 5 to 25) is given, this means preferably at least 5 and, separately and independently, preferably not more than 25. Also, the non-volatile components of a coating composition for depositing a low-refractive index layer via a wet coating process are referred to herein collectively as “solids.” This terminology is a convention of the AR coatings art, and is applicable to all non-volatile components of coating compositions irrespective of the actual material phase of a specific non-volatile component. Unless otherwise specifically indicated, all components in the coating compositions described herein, except for the solvent, are solids because they are non-volatile and are left behind on the substrate surface once the volatile solvent has evaporated. Also as used herein, the refractive index of a layer or material is the index for the given layer or material relative to air.

Herein, a low-refractive index layer is deposited onto a substrate via a wet coating process from a coating composition having no or substantially no halogenated solvent. The coating compositions disclosed herein are substantially devoid of halogenated solvents, meaning that no halogenated solvents are intentionally provided or included as a component of the composition. The composition includes a fluorinated copolymer that is soluble, and is dissolved, in a non-halogenated solvent. As used herein, a non-halogenated solvent is one where the principal species forming the solvent is devoid or substantially devoid of halogen atoms, and which does not include any halogen atoms or halogenated species in any significant or substantial amount, e.g., greater than 0.1 or 0.2 weight percent of total solvent. A non-halogenated solvent may include trace or low level concentrations of halogens or of halogenated species as impurities that are or may be present in commercially available sources for such non-halogenated solvents.

In practice, a substrate surface is coated with the copolymer-solvent composition and the solvent is evaporated leaving behind the non-volatile copolymer deposited on the substrate surface. The coating composition also can include other conventional components such as cross-linking agents, thickeners, etc. as more fully described below. The coating composition includes the components in the component concentrations listed below in table 1. In table 1, it is not necessary that the concentrations for all components of a particular composition come from the same column; coating compositions can be prepared by selecting a concentration for each component from different columns.

TABLE 1

| Component | Preferred | Less Preferred | Less Preferred |
|---|---|---|---|
| Fluorinated | 2-12 | 1-15 | 0.5-20 |
| copolymer | | | |
| Solvent | 95-88 | 70-97 | 50-99 |
| Cross-linking | 0.2-2 | 3-30 | 0-80 |
| agent | | 4-20 | 2-40 |
| | | 0.1-3 | 0.1-10 |
| Initiator | 0.02-.2 | 0.01-.3 | 0.01-1 |
| Thickener | 0.2-2 | 0.1-3 | 0.1-10 |

A coating composition comprising the components in the concentrations as disclosed in table 1 can be made, for example, by the following method. Combine all of the solid components (copolymer, cross-linking agent, initiator, thickener) together without solvent to achieve the desired non-volatile solids mixture including all these components. Subsequently, the non-volatile solids mixture is dissolved in a non-halogenated organic solvent and diluted to the desired solvent concentration as provided in table 1. Alternatively, other modes of preparing a coating composition based on the component concentrations listed in table 1 are possible and can be used, which will be immediately apparent to a person having ordinary skill in the art. Each of the components of the coating composition set forth in table 1 will now be described.

The Copolymer

The fluorinated copolymer in table 1 is a copolymer of at least three different species of monomer, wherein at least one of the monomeric species is a fluorinated species. Herein, a fluorinated species refers to a monomeric species having at least one fluorine atom. When the copolymer is made up of three monomeric species, it is referred to herein as a terpolymer. Analogously, a copolymer made up of four monomeric species is referred to as a tetrapolymer, one made up of five monomeric species, a pentapolymer, etc.

The copolymer has the following elemental composition listed in table 2. In table 2, all percentages are percentages by weight of the specified atom in the copolymer, taking account of all occurrences of that atom in all the monomeric units of the copolymer. It is not necessary that all the concentrations for each of the elements for a given copolymer come from the same column in table 2.

TABLE 2

| Atom | Preferred | Less Preferred | Less Preferred |
|---|---|---|---|
| Carbon (C) | 30-40 | 25-30 | 20-45% |
| Hydrogen (H) | 0-3 | 0-4 | 0-5% |
| Fluorine (F) | 60-70 | 55-75 | 50-77% |
| Oxygen (O) | 0-10 | 0-15 | 0-20% |

It is noted that table 2 indicates the elemental concentrations of both hydrogen and oxygen can be zero. However, it is desirable that at least one of these elements be present in the copolymer, and that the copolymer not omit both hydrogen and oxygen entirely. It also is noted the fluorinated copolymer is not necessarily limited to containing only the elements listed in table 2. Other elements may be present, either as impurities or by design to impart desirable properties so long as the inclusion of such other elements does not prevent the fluorinated copolymer from being soluble in non-halogenated solvents as described beginning in the next paragraph.

It has been discovered, surprisingly and unexpectedly, that fluorinated copolymers made up of at least three different species of monomeric units, and having elemental compositions as provided in table 2, are soluble in conventional non-halogenated organic solvents. Thus, it is for the first time possible to provide a fluorinated low-refractive index layer for an AR coating via a wet coating process, having a low refractive index based on the fluorinated copolymer, but without using a halogenated solvent. Exemplary non-halogenated organic solvents useful in a wet coating process include, but are not limited to, methyl ethyl ketone, methyl isobutyl ketone, tetrahydrofuran, propylene glycol monomethyl ether, N,N-dimethylformamide, dimethyl sulfoxide, methanol, toluene and ethyl acetate.

A fluorinated copolymer as disclosed herein can be prepared as a random or a block copolymer consisting of three or more different species of monomer, wherein at least one of the monomers is a fluorinated species. To make a random copolymer, one need only combine the selected monomeric species in appropriate amounts to achieve an elemental composition for the overall copolymer as described in table 2 above, and permit the polymerization reaction to proceed in a conventional manner using conventional techniques, catalysts, initiators, etc. The fluorinated copolymer can be prepared using the common free radical polymerization process. In this method, vinyl moieties of the monomers are polymerized by radical initiators, e.g., benzoyl peroxide and 2-2′-azo-bis-isobutyrylnitrile (AIBN). The fluorinated copolymer is formed through a chain reaction mechanism as known in the art, and the polymer chains are self terminated through coupling reactions or in the presence of air. Suitable random copolymers have been synthesized that exhibit desirable optical and physical properties (low refractive index and good wettability to a variety of substrates), yet they remain soluble in non-halogenated organic solvents such as methyl ethyl ketone (MEK). Therefore, it is not necessary to undertake the complexity and additional time and expense to achieve an ordered block copolymer from the polymerization reaction because random copolymers have been found to exhibit suitable optical and physical properties and are soluble in non-halogenated solvents. However, in certain circumstances it may be desirable to provide a block copolymer, and such copolymers, which can be prepared via known or conventional techniques, are considered within the scope of the invention.

Terpolymers composed of the following three-monomer systems can be prepared that meet the above-described compositional criteria by adjusting the relative monomeric concentrations in each terpolymer. This list is not considered to be exhaustive:
tetrafluoroethylene-ethylene-vinylidene fluoride (TFE-ET-VF)
perfluorovinyl ether-hexafluoropropylene-vinylidene fluoride (PFV-HFP-VF)
tetrafluoroethylene-hexafluoropropylene-ethylene (TFE-ET-HFP)
hexafluoropropylene-perfluorovinyl ether-tetrafluoroethylene (HFP-PFV-TFE)
tetrafluoroethylene-hexafluoropropylene-vinylidene fluoride (TFE-HFP-VF)
octafluoropentanol acrylate, hexafluoropropylene, and perfluorovinyl ether (OFPA-HFP-PFV).

Without wishing to be bound by a particular theory, it is believed the fluorinated copolymers described herein are highly soluble in non-halogenated organic solvents for at least one of the following reasons. Generally, halogenated organic solvents, such as freons or chlorinated solvents, have been required to solvate and dissolve halogenated organic compounds. This is because halogens are strongly electronegative atoms, and they have a strong polarizing effect on organic molecules on which they are substituted. Strongly polar molecules generally are not soluble in nonpolar organic solvents such as conventional non-halogenated solvents. In particular, fluorinated homopolymers such as PTFE and HFP cannot be dissolved in non-halogenated solvents. However, when the individual monomeric units of these as well as other fluorinated and non-fluorinated monomers are combined to provide a sufficiently diverse (i.e. composed of at least three distinct monomeric species) fluorinated copolymer, it has been found by the present inventor that the resulting copolymer is soluble in non-halogenated organic solvents so long as its elemental composition is within the ranges disclosed in table 2. This effect is believed to result from the following.

A sufficiently diverse copolymer, such as one composed of at least three distinct monomeric species, will have a relatively branched and amorphous structure. The degree of amorphousness increases as the copolymer composition becomes more diverse, meaning that terpolymers are more branched and amorphous than bi-polymers, tetrapolymers more so than terpolymers, pentapolymers more so than tetrapolymers, etc. As the fluorinated copolymer becomes more diverse and therefore more randomized, the organic character of the macromolecules approaches and ultimately overcomes the effect of the periodic or sporadic fluorination sites which tend to polarize the macromolecules. At some point, this organic character of the copolymer macromolecules becomes controlling of their solubility in nonpolar organic solvents. Once the macromolecules' organic character has become strong enough relative to the polarizing effect of the fluorination sites on the macromolecules, the molecules can be dissolved in non-halogenated organic solvents which are substantially nonpolar.

Conversely, a fluorinated homopolymer such as PTFE is sufficiently ordered and linear, and contains a substantial number of fluorine atoms (four per monomeric unit in the case of PTFE) located at ordered and periodic sites along a substantially linear molecule, such that a halogenated solvent is necessary to dissolve the macromolecule. The need for a halogenated solvent also has been observed in order to dissolve binary polymers consisting of only two species of monomer. However, fluorinated terpolymers such as those described in the examples below have been found to exhibit a high degree of solubility in conventional non-halogenated solvents such as MEK and MIBK (methyl isobutyl ketone). Additionally, these terpolymers have been shown (see examples) to exhibit excellent low refractive indices, high transparency and wettability properties.

Based on the above, it is expected that higher order fluorinated copolymers, for example tetrapolymers and pentapolymers composed of four or five monomeric species, having elemental compositions as provided in table 2 also should exhibit a high degree of solubility in non-halogenated organic solvents. Such higher order copolymers are considered to be within the scope of the present invention, as suitable compositions thereof can be determined by persons of ordinary skill in the art without undue experimentation based on the present disclosure.

The described fluorinated copolymers exhibit excellent optical properties, in addition to being soluble in non-halogenated solvents. In particular, such copolymers have been shown to exhibit refractive indices at 589 nm measured at 25° C. about or less than 1.45, and preferably about or less than 1.40. Refractive indices of 1.38, 1.375 and 1.37 (measured at the conditions noted in the preceding sentence) have been achieved for low-refractive index layers comprising fluorinated copolymers disclosed herein. In a preferred embodiment, the copolymer exhibits a refractive index of 1.30-1.40 or 1.30-1.38 for light of 589 nm wavelength measured at 25° C. AR coatings using a low refractive index (RI) layer with an RI less than 1.40 have been demonstrated to achieve net reflection ratios of less than about 1% visible light at 589 nm measured at 25° C. when the low RI layer has appropriate thickness and is coated on an appropriate substrate as known to those of ordinary skill in the art. Indeed, fluorinated copolymers can be prepared as described herein for making low RI layers that (together with corresponding or alternating suitable high RI layers) provide reflection ratios for the anti-refractive coating of less than 8, 7, 6, 5, 4, 3, 2 or 1, percent (at 589 nm at 25° C.). In addition, the disclosed copolymers produce low-refractive index layers having high transmittance and no or negligible haze. A low refractive index layer made using a fluorinated copolymer of the present invention exhibits a transmittance of at least 90, 92, 94, 96 or 98 percent of visible light measured at 589 nm at 25° C. for a layer thickness of about 0.1 μm.

In addition to the optical properties noted above, the fluorinated copolymers disclosed herein also exhibit excellent physical properties that make them highly suitable for use in wet coating processes to deposit low-refractive index layers for AR coatings. Specifically, the copolymers exhibit good to excellent wetting performance for a wide range of substrates on which low-refractive index layers conventionally are deposited, ranging from high-refractive index layer materials to conventional display substrates including glass, PET and TAC. Good wettability is important because once the organic solvent has evaporated (described more fully below), the precipitated copolymer left on the coated surface generally is in the state of a viscous liquid or gel layer. Thus, the copolymer precipitate or gel must be sufficiently wetting of the substrate on which it is deposited to ensure the copolymer precipitate or gel remains spread over the entire substrate surface and does not flocculate into small beads or into one large bead on the surface prior to curing or cross-linking. This is important to provide and sustain a uniform layer of substantially constant thickness over the entire coated surface.

Solvent

The solvent is a non-halogenated organic solvent and can be selected from among a variety of conventional solvents. Optionally, the solvent can be a mixture of such solvents. The solvent is used to dissolve the fluorinated copolymer and other solid components so the copolymer can be uniformly coated onto a substrate to achieve a uniform layer of precisely controlled thickness, such as 1 μm or 0.1 μm. Generally the copolymers disclosed herein are solids or highly viscous liquids or gels that do not lend themselves well to being coated onto a substrate to provide precisely metered and uniform low thickness layers. By dissolving the copolymer into a suitable low viscosity solvent, a low to medium viscosity composition is provided that is useful to deposit the copolymer onto a substrate surface, and following evaporation of the solvent to achieve a uniform layer thickness on the order of <1 μm despite the relatively high viscosity of the copolymer by itself. Essentially, the solvent is used as a processing aid or diluent to adjust the processivity of the copolymer composition so that it can be precisely coated onto a substrate to achieve a layer of desired thickness that is uniform across the entire coated surface, which can be on the order of 0.05 to 5 μm depending on the application. Because the solvent-copolymer solution is used to coat the substrate surface, it also is important to select a solvent that exhibits sufficient wettability with respect to the substrate in order to achieve a uniformly coated substrate. It is contemplated that some degree of experimentation may be desirable to select an appropriate solvent for a particular application. This is in part because, as will be understood, different solvents may result in different or varying surface coating textures on various substrates. The degree of contemplated experimentation is within the ability of a person having ordinary skill in the art, and is not undue for selecting an appropriate non-halogenated solvent for a particular coating application based on factors such as the substrate material and the desired copolymer composition, in view of the criteria herein disclosed.

Exemplary non-halogenated organic solvents include but are not limited to methyl ethyl ketone (MEK), methyl isobutyl ketone (MIBK), ethyl acetate, isopropanol (IPA), methanol, propylene glycol (PG), propylene glycol monomethyl ether, and toluene. For most wet coating process applications, it is desirable that sufficient solvent be present in the coating composition to achieve low viscosity (<2,000 cps) to ensure suitable processivity and coating characteristics. It has been found that a coating composition made as described herein with adequate solvent to achieve a low viscosity (see examples), can be used effectively to produce uniform coating composition layers on a substrate surface via conventional coating techniques such as those described hereinbelow.

Cross-Linking Agent and Initiator

In certain applications, it is desirable the low-refractive index layer exhibit a high degree of hardness and/or solvent resistance. This can be important to prevent scratching or damaging the layer when, for example, the resulting AR coating will not be shielded as by a sheet of glass or plastic, or where the surface to which the coating is applied is intended as an interface designed to be contacted using a stylus or a finger. When a hard layer is desired, a cross-linking agent or a cross-linker can be included in the coating composition in an amount effective for forming a three dimentional solid matrix of thermoset resin. The cured cross-linkers add cross-link density to the final coating to improve hardness and solvent resistance of the coating. Cross-linking also improves the solvent resistance of the layer in the event it should come in contact with a solvent (i.e. accidentally such as a spill) during use. The cross-linking agent can be radiation- (such as UV, EB or visible light), heat- or moisture-curable or activated depending on the application, and a person of ordinary skill in the art can select appropriate cross-linking agents activated by a suitable one of these mechanisms. The reactive moieties of the cross-linking agent can be, e.g., acrylate, epoxy, cyanate, vinyl, silanol, sulfur, isocyanate or a combination of these.

All of the above cross-linking agents can be obtained from well known sources or coating suppliers, such as Sartomer, UCB-Radcure, Dow Chemical Corporation, Nippon Goshei, Nippon Kayaku, etc.

Depending on the desired curing method (radiation, moisture or heat) for cross-linking, appropriate initiator molecules also can be included, the selection of which also is within the ability of a person having ordinary skill in the art. For example, photo-radical and photo-cationic initiators can be selected to achieve a radiation curing mode, whereas thermal-radical and thermal-cationic initiators can be selected to achieve a heat curing mode. Photo-radical initiators include but are not limited to the following: acetophenones, benzoins, benzophenones, phosphine oxides, ketals, thioxanthones and the like. Photo-cationic initiators include but are not limited to antimony-based and phosphorus-based initiators available from Dow Chemical Corporation. Thermal-radical initiators include but are not limited to organic peroxides or azo compounds such as benzoyl peroxide, lauroyl peroxide, acetyl peroxide, dibutyl peroxide azo-bis-isobutyronitrile (AIBN), etc., or the like. Thermal-cationic initiators include epoxies such as the typical amine or anhydride hardeners available from Dow Chemical Corporation. Suitable ones of all of the above can be obtained from, e.g., Ciba Geigy and Sartomer in addition to Dow Chemical, as well as other well known suppliers of specialty chemical additives.

It is noted that most cross-linking agent materials exhibit relatively high indices of refraction, such as about or greater than 1.5@589 nm, 25° C. Thus, it is important when selecting a cross-linking agent for the coating composition (if one is to be used) to consider the effect on the refractive index of the overall solids composition based on the addition of the cross-linking agent. Generally, determining an appropriate amount of cross-linking agent will involve balancing the degree of cross-linking necessary to achieve a desired hardness for the low-refractive index layer, with the need to maintain the refractive index of that layer below a certain value. Other factors, such as the end use to which the coated substrate will be put and the prevailing conditions thereof, also should be considered. The initiator also may have a relatively high refractive index. However, the concentration of the initiator in the coating composition is low enough that its effect on the refractive index of the overall composition, and therefore on the resulting low-refractive index layer, is substantially negligible.

When hardness of the low-refractive index layer is of importance, it is desirable that this layer have a pencil hardness of at least HB on the conventional pencil hardness scale, with 2 H or 3 H on that scale being preferred. Where hardness of the low-refractive index layer is not of particular concern, the layer still preferably exhibits a hardness of at least F on the pencil hardness scale. F-hardness can be achieved by layers composed of the fluorinated copolymers described herein without any cross-linking.

Thickener

A thickener also can be used to improve the adhesion of the low refractive index layer to the base substrate as well as to reduce the shrinkage of the low refractive index layer. Suitable thickening agents can be the typical acrylic polymers such as acrylic resins, rosin resins, terpene resins or any type of inert thermoplastic resins that are soluble in organic solvents.

The Low-Refractive Index Layer

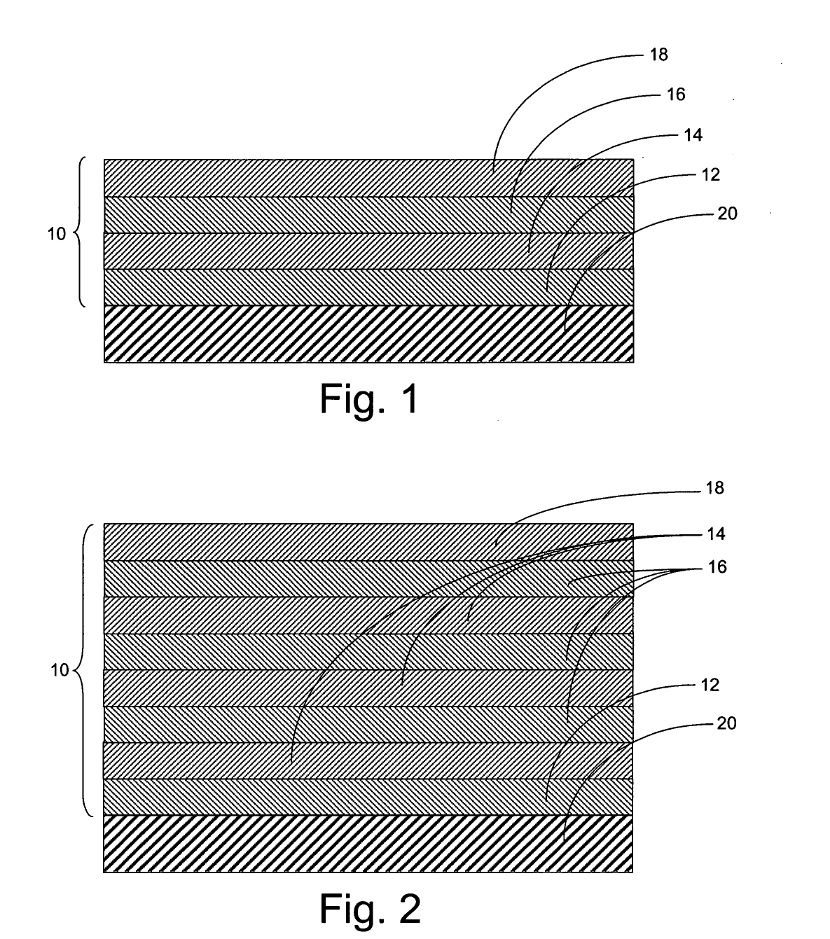

A low-refractive index layer deposited from a coating composition as described above, as well as methods of depositing it from such a coating composition, now will be described. Referring to FIG. 1, the layered structure of a typical AR coating 10 on a substrate 20 is shown. In the illustrated embodiment, the AR coating 10 includes a hard coating 12, a high refractive index layer 14, a low refractive index layer 16 and an anti-smudge layer 18. These four layers generally are considered part of the AR coating 10, though it is principally the low- and high-refractive index layers 16 and 14 that produce the anti-refractive properties. The substrate 20 material can be any material or surface to which it is desired to apply an AR coating 10. Conventional substrate 20 materials include glass, polyethylene terephthalate (PET), polymethyl methacrylate (PMMA), polycarbonate (PC) and tri-acetate cellulose (TAC), as well as other known materials that can provide a substantially transparent surface or layer. The illustrated hard coating layer 12 is an optional layer that may or may not be applied depending on whether the entire layered structure, including the AR coating 10, will be shielded by a hard layer or casing, such as a transparent plastic or glass cover. If the AR coating 10 will be shielded from contact with external elements, the hard coating layer 12 shown in FIG. 1 may be omitted. Otherwise, if the layered structure will not be shielded then the hard coating 12 may be desired to ensure the base substrate is not damaged through contact with external elements. Generally, a hard coating layer 12 is not necessary when the substrate is glass because glass is relatively hard. The hard coating layer 12 may be desirable in cases where the substrate is made of PET which is a relatively soft material and is easily scratched.

The anti-smudge layer 18 which is the outermost layer of the AR coating 10 also is an optional layer. This layer most commonly is used for touch-panel displays where the panel serves as a human interface designed to accept inputs from a human finger depressing the display surface. The anti-smudge layer 18 is effective to prevent or reduce the appearance of smudges, such as from deposited skin oils. Anti-smudge layers generally are known in the art and can be deposited using conventional materials such as hydrocarbon oils or fluorinated hydrocarbon oils, via conventional techniques.

The low- and high-refractive index layers 16 and 14 of the AR coating 10 impart the principal anti-refractive property to the coating in a well known manner. Briefly, the alternating low- and high-refractive index layers cooperate to achieve a phase-shift, preferably of about 180°, in the wavelengths comprising the visible light spectrum on refraction of visible light waves. The result is visible light waves reflected from the surface and interface of a layer are shifted about 180° out of phase such that optical interference occurs and the net reflected light in the visible spectrum is zero or substantially zero, meaning that reflected light waves are substantially canceled out. The principles of refraction governing the operation of anti-refractive coatings (including the use of alternating high- and low-refractive index layers) summarized here are well known in the art and will not be further described. It is noted, however, in certain applications it is desirable to include multiple pairs of alternating high- and low-refractive index layers 14 and 16 as shown in FIG. 2. AR coatings having multiple cooperating pairs of low- and high-refractive index layers can be made such that different low refractive index layers have the same or different compositions, more particularly the same or different material which is principally responsible for producing the low refractive index for the layer; e.g., the fluorinated copolymers disclosed herein which are soluble in a non-halogenated organic solvent. In one embodiment, one or several of the low refractive index layers for a particular AR coating can be provided from a fluorinated copolymer as disclosed herein, while other low refractive index layers have or are made using other conventional low refractive index materials.

It is noted generally that to achieve an anti-refractive coating, all that is necessary is to have at least one pair of cooperating high- and low-refractive index layers that are effective in combination to achieve the appropriate visible light phase shift. However, in some cases it is possible to omit a separate high-refractive index layer, such as when the material of the substrate itself has a relatively high index of refraction, such as about or greater than 1.50. In this case, the substrate layer itself behaves as a high-refractive index layer and can cooperate with a superjacently applied low-refractive index layer to achieve the desired phase shift. PET in particular has a relatively high index of refraction (typically about 1.62@589 nm, 25° C.). Thus, when PET or a material of similarly high RI is used as the substrate material, it may be desirable to omit the separate high-refractive index layer. Alternatively, for an AR coating where multiple pairs of cooperating high- and low-refractive index layers are to be used, the lowermost or foundational separate high-refractive index layer may be omitted, and a low-refractive index layer as described herein can be deposited directly to a high-refractive index substrate. Subsequently, alternating separate layers of high- and low-refractive index materials can be provided thereover.

Returning to the low-refractive index layer, this layer can be provided and deposited as follows. First, the appropriate fluorinated copolymer system is selected based on the application. For purposes of discussion, the case of a fluorinated terpolymer is assumed here but the invention is not to be correspondingly so limited. Once the monomeric species for the particular terpolymer have been selected, and the respective concentrations of each monomer have been determined to achieve an elemental composition in accordance with table 2, (for example 20 wt. % TFE, 10 wt. % ET and 70 wt. % VF), the monomers are combined and polymerized to form the desired copolymer. The monomers can be randomly polymerized, or the polymerization reaction can be controlled to achieve a block copolymer of the three monomers via known techniques. Next, the terpolymer is combined and mixed with appropriate quantities of additional optional solids components, including a cross-linking agent and an initiator if present, in appropriate amounts to achieve an overall composition, on dissolution in a non-halogenated solvent, as disclosed in table 1. Additionally, other known or conventional additives can be included in conventional amounts to achieve desired physical or chemical properties for the finished layer or for the coating composition. Without limitation, exemplary additives may include surfactants, thickeners, pigments, non-volatile oils, adhesion promoter agents, anti-foam agents, etc. In particular, surfactants can be included in the coating compositions described herein as a processing aid, and can be selected from among, e.g., silicon-based surfactants, hydrocarbon-based surfactants and fluorocarbon-based surfactants.

Once all of the non-volatile components have been combined to achieve the desired non-volatile solids mixture, an appropriate solvent is selected and combined with the solids mixture to achieve an overall coating composition having component concentrations as described in table 1.

The resulting coating composition can be provided to a reservoir from which it is applied via a wet coating process to a web of material that is conveyed through an application/coating station in a conventional manner where a desired uniform thickness of the coating composition is applied to the web surface. Wet coating processes and coating techniques are well known in the art, and include, e.g. wire bar coating, dip coating, air-knife coating, curtain coating, roller coating, gravure coating, spray coating, roll to roll, etc. The web that is being coated can be a display substrate material surface such as glass or PET, or it can be a separate high-refractive index layer that has been previously applied and cured (if necessary) onto a substrate.

The thickness of the wet coating composition that is applied is governed by the solvent concentration in the composition and the desired final thickness of the low-refractive index layer once the solvent has been evaporated. Selection of the final layer thickness is governed by the wavelength of the light for which it is desired to reduce or eliminate refraction based on the formula δ=λ/4, where δ is the thickness of the low-refractive index layer and λ is the light wavelength. This is because each of the high- and low-refractive index layers in a cooperating pair of the layers should have a thickness equal to ¼ of the light wavelength (total thickness of each pair being ½ the light wavelength) to achieve the ideal 180° phase shift described above. In practice, exact ¼ wavelength thickness of these layers may not be achieved, but it is a general design target for the layers. While the ¼ wavelength thickness described in this paragraph is desirable, other thicknesses also may work. Each of the refractive layers in a cooperating pair should be thin (typically ¼ wavelength), but thinner layers also would work depending on the multi-layer structure based on known principles.

The average wavelength of visible light is about 550 nm, resulting in a layer thickness, δ, for visible light applications of 550/4 which equals about 137 nm or 0.14 μm. Generally, for solvent concentrations in the range of about 90-98, more particularly 90-96 or 93-96 weight percent (corresponding to 2-10, more particularly 4-10 or 4-7 weight percent solids), a wet coating composition thickness of about 5-7 μm has been found to produce a precipitated solids layer thickness following solvent evaporation in the range of about 0.05-0.2 μm, more particularly of about 0.1 μm. After the wet coating composition has been applied to the substrate (web) surface, the solvent is permitted or caused to evaporate thereby leaving behind and depositing the copolymer and other non-volatile components onto the substrate surface. Depending on the coating process, the solvent can be permitted to dry at ambient temperature such as at 25° C., or the composition can be heated such as by conveying the coated substrate web through an evaporation oven or a conventional drying oven or IR drying oven to accelerate solvent evaporation.

Once the solvent has evaporated, the residual non-volatile components deposited onto the substrate surface form the low-refractive index layer. If the layer is to be cross-linked, cross-linking subsequently is initiated based on the applicable mode (heat, radiation, moisture) to achieve a fully cured low-refractive index layer of the desired hardness. Subsequently, any superjacent layers that are to be applied over the just-applied low-refractive index layer can be so applied in a conventional manner to produce a finished AR coating having the desired order and type of layers.

Further aspects of the invention will become evident in conjunction with the following examples, which are provided by way of illustration and not limitation.

### EXAMPLE 1

A coating composition was prepared using the following fluorinated terpolymer:
20 wt. % tetrafluoroethylene (TFE)
10 wt. % ethylene (ET)
70 wt. % vinylidene fluoride (VF)

The TFE-ET-VF terpolymer in this example was a random copolymer.

The coating composition was prepared by first combining the following solid (i.e. non-volatile) components to achieve a non-volatile solids mixture having the following composition:
88 wt. % 20% TFE-10% ET-70% VF fluorinated terpolymer
10 wt. % urethane acrylate (CN 964) cross-linking agent available from Sartomer
2 wt. % Irgacure 184 which is an alpha-hydroxy ketone UV-photo initiator available from Ciba Specialty Chemicals.

Next, the above solids mixture was dissolved in methyl ethyl ketone (MEK) solvent to a total overall solvent concentration of 75% MEK by weight. Thus, the total overall composition of the resulting coating composition (including solvent) is provided below in table 3.

TABLE 3
Coating composition for Example 1

| | Weight percent in |
|---|---|
| Component | total composition |
| 20% TFE-10% ET-70% VF terpolymer | 22 |
| Cross-linker (urethane acrylate) | 2.5 |
| UV-photo initiator (α-hydroxy ketone) | 0.5 |
| MEK (solvent) | 75 |

In this composition, the terpolymer was substantially completely dissolved in the MEK solvent despite the fact that MEK is a non-halogenated solvent. The composition was monophasic meaning that there was no phase separation evident in the solution which might evidence incomplete dissolution of the terpolymer in the MEK. The viscosity of this coating composition was 1,000 to 1,500 cps at 25° C. making it highly suitable for coating onto substrates via conventional wet coating processes such as wire bar coating, air-knife coating and the like.

This composition has been shown to provide a deposited low-refractive index layer, following evaporation of the solvent and UV-initiated cross-linking of the terpolymer, having a refractive index of 1.380 (589 nm at 25° C.).

### EXAMPLE 2

An anti-refractive (AR) coating was prepared and deposited onto a transparent substrate film made of PET. The AR coating was a two-layer coating composed of a pair of high- and low-refractive index layers. To make the coating, first the high-refractive index layer was deposited onto the PET substrate surface via a wire bar coating process using a coating composition comprising 7 wt. % solids and 93% methyl isobutyl ketone (MIBK) solvent. The thickness of the deposited high refractive index layer coating composition was 0.1 μm. Following deposition of this coating the MIBK solvent was evaporated in a convection oven at 80° C. for two minutes. The solvent-dried layer then was polymerized via exposure to UV irradiation (UV dose of 1 J/cm²) thereby forming the finished high-refractive index layer having a thickness of ca. 0.1 μm, which was determined to have a refractive index of 1.65 (589 nm at 25° C.). The principal high refractive index material used for this high refractive index layer is titanium dioxide based coating.

Subsequently, a low-refractive index layer was deposited over the high-refractive index layer by coating the high-refractive index layer surface with the coating composition for the low-refractive index layer via a similar wire bar coating process. The coating composition for the low-refractive index layer was as described in EXAMPLE 1 except that the solvent used was MIBK instead of MEK, and the solvent concentration in the coating composition for this experiment was 92 wt. % (8 wt. % solids), compared with 75 wt. % in EXAMPLE 1. After the low-refractive index layer coating composition was applied (to a coating thickness of ca. 0.1 μm), the solvent was evaporated similarly as for the high-refractive index layer in a convection oven at 80° C. for two minutes. Cross-linking was completed by exposure of the solvent-dried layer to 1 J/cm² UV radiation and the resulting low-refractive index layer had a layer thickness of ca. 0.1 μm and was determined to have a refractive index of 1.38 (589 nm at 25° C.).

The resulting AR coating composed of the above-described high- and low-refractive index layers was tested and the following properties were measured.

TABLE 4
Properties of AR coating prepared in Example 2

| Property | Result |
|---|---|
| Average reflectance (%) | <1% |
| | (incident radiation 550-750 nm) |
| % transmittance | >95% |
| % haze | <0.4% |
| Pencil hardness | HB-H |

### EXAMPLE 3

Another coating composition was prepared using the following fluorinated terpolymer:
20 wt. % tetrafluoroethylene (TFE)
10 wt. % hexafluoropropylene (HFP)
70 wt. % vinylidene fluoride (VF)

The TFE-HFP-VF terpolymer in this example was a random copolymer.

The coating composition was prepared by first combining the following solid (i.e. non-volatile) components to achieve a non-volatile solids mixture having the following composition:
88 wt. % 20% TFE-10% HFP-70% VF fluorinated terpolymer
10.8 wt. % bisphenol A epoxy resin (Der 331) available from Dow Chemical
1.2 wt. % UVI 6996 initiator, which is a cationic photoinitiator available from Dow Chemical or BASF.

Next, the above solids mixture was dissolved in methyl ethyl ketone (MEK) solvent to a total overall solvent concentration of 75% MEK by weight. Thus, the total overall composition of the resulting coating composition (including solvent) is provided below in table 5.

TABLE 5
Coating composition for Example 3

| | Weight percent in |
|---|---|
| Component | total composition |
| 20% TFE-10% HFP-70% VF terpolymer | 22 |
| Cross-linker (urethane acrylate) | 2.7 |
| UV-photo initiator (α-hydroxy ketone) | 0.3 |
| MEK (solvent) | 75 |

In this composition, the terpolymer was substantially completely dissolved in the MEK solvent despite the fact that MEK is a non-halogenated solvent. The composition was monophasic meaning that there was no phase separation evident in the solution which might evidence incomplete dissolution of the terpolymer in the MEK. The viscosity of this coating composition was 800 to 900 cps at 25° C. making it highly suitable for coating onto substrates via conventional wet coating processes such as wire bar coating, air-knife coating and the like.

This composition has been shown to provide a deposited low-refractive index layer, following evaporation of the solvent and UV-initiated cross-linking of the terpolymer, having a refractive index of 1.375 (589 nm at 25° C.).

### EXAMPLE 4

Another coating composition was prepared using the following fluorinated terpolymer:
40 wt. % perfluorovinyl ether (PFV)
10 wt. % hexafluoropropylene (HFP)
50 wt. % vinylidene fluoride (VF)

The PFV-HFP-VF terpolymer in this example was a random copolymer.

The coating composition was prepared by first combining the following solid (i.e. non-volatile) components to achieve a non-volatile solids mixture having the following composition:
88 wt. % 40% PFV-10% HFP-50% VF fluorinated terpolymer
10 wt. % urethane acrylate (CN 964) cross-linking agent available from Sartomer
2 wt. % benzoyl peroxide thermal initiator.

Next, the above solids mixture was dissolved in methyl ethyl ketone (MEK) solvent to a total overall solvent concentration of 75% MEK by weight. Thus, the total overall composition of the resulting coating composition (including solvent) is provided below in table 6.

TABLE 6
Coating composition for Example 4

| | Weight percent in |
|---|---|
| Component | total composition |
| 40% PFV-10% HFP-50% VF terpolymer | 22 |
| Cross-linker (urethane acrylate) | 2.5 |
| thermal initiator (benzoyl peroxide) | 0.5 |
| MEK (solvent) | 75 |

In this composition, the terpolymer was substantially completely dissolved in the MEK solvent despite the fact that MEK is a non-halogenated solvent. The composition was monophasic meaning that there was no phase separation evident in the solution which might evidence incomplete dissolution of the terpolymer in the MEK. The viscosity of this coating composition was 1,000 to 1,100 cps at 25° C. making it highly suitable for coating onto substrates via conventional wet coating processes such as wire bar coating, air-knife coating and the like.

This composition has been shown to provide a deposited low-refractive index layer, following evaporation of the solvent and heat-initiated cross-linking of the terpolymer, having a refractive index of 1.370 (589 nm at 25° C.).

As the above examples demonstrate, it is possible to provide a low-refractive index layer having a refractive index in the range of, e.g., 1.370 to 1.45, which can be deposited from a coating composition whose viscosity is suitable for wet coating processes, using only non-halogenated solvents. The low-refractive index polymers disclosed herein are highly soluble in conventional non-halogenated organic solvents despite their fluorine content which is desirable for the observed optical properties of the deposited layers. Particularly advantageous is that it is possible to coat large continuous webs of substrate material with a solvent-deposited low-refractive index layer from a low viscosity coating composition via a steady-state wet coating process that does not use or require halogenated solvents. It will be recognized that the selection of an appropriate non-halogenated organic solvent, as well as an appropriate fluorinated copolymer, may depend to some extent on the substrate material whose surface is to be coated with a low refractive index layer. This is because different solvents and/or copolymers may exhibit differing degrees of wettability to a particular substrate, and these should be selected based on good wettability behavior for the substrate it is desired to coat.

In summary, relatively low cost methods and materials now can be used to produce low-refractive index layers that can be deposited via wet coating processes without the use of halogenated solvents. In particular, conventional non-halogenated commodity solvents such as methyl ethyl ketone, isopropyl alcohol, ethyl acetate, and methyl isobutyl ketone can be used as the dilution solvents for the fluorinated copolymers disclosed herein despite their fluorine content which is desirable for producing suitable optical properties for the deposited low RI layers. This feature eliminates the need for halogenated solvents that are both expensive and environmentally unfriendly.

Although the hereinabove described embodiments of the invention constitute preferred embodiments, it will be understood that modifications can be made thereto without departing from the spirit and scope of the invention as set forth in the appended claims.

What is claimed is:

1. A composition comprising a fluorinated copolymer of at least three different monomeric species, at least one of said monomeric species being a fluorinated species, said fluorinated copolymer being soluble and dissolved in a non-halogenated organic solvent.

2. A composition according to claim 1, said fluorinated copolymer being a fluorinated terpolymer.

3. A composition according to claim 2, said fluorinated terpolymer comprising the following elements in the following percentages by weight:
20-45% carbon;
0-5% hydrogen;
50-77% fluorine; and
0-20% oxygen;
wherein the terpolymer includes at least one of hydrogen or oxygen.

4. A composition according to claim 2, said fluorinated terpolymer being selected from the group consisting of:
a) 20% TFE-10% ET-70% VF;
b) 20% TFE-10% HFP-70% VF; and
c) 40% PFV-10% HFP-50% VF;
wherein all percentages are percentages by weight of the specified monomer in the respective terpolymer.

5. A composition according to claim 2, further comprising a cross-linking agent.

6. A composition according to claim 5, said cross-linking agent being selected from the group consisting of acrylate, epoxy and cyanate cross-linking agents.

7. A composition according to claim 2, said cross-linking agent being radiation-activated, heat-activated or moisture-activated.

8. A composition according to 2, further comprising initiator molecules.

9. A composition according to claim 8, said initiator molecules being photo initiator molecules.

10. A composition according to claim 8, said initiator molecules being thermal initiator molecules.

11. A composition according to claim 2, further comprising a thickener.

12. A composition according to claim 11, said thickener being an acrylic polymer.

13. A composition according to claim 11, said thickener being selected from the group consisting of acrylic resins, rosin resins and terpene resins.

14. A composition according to claim 2, further comprising a surfactant selected from the group consisting of silicon-based surfactants, hydrocarbon-based surfactants and fluorocarbon-based surfactants.

15. A low refractive index layer comprising a fluorinated copolymer of at least three different species of monomeric units, wherein at least one of said species of monomeric units is a fluorinated species, said fluorinated copolymer being soluble in a non-halogenated organic solvent.

16. A low refractive index layer according to claim 15, said low refractive index layer having a refractive index about or less than 1.45 for light of 589 nm wavelength measured at 25° C.

17. A low refractive index layer according to claim 15, said low refractive index layer having a refractive index about or less than 1.40 for light of 589 nm wavelength measured at 25° C.

18. A low refractive index layer according to claim 15, said low refractive index layer having a refractive index of 1.30 to 1.38 for light of 589 nm wavelength measured at 25° C.

19. A low refractive index layer according to claim 15, said fluorinated copolymer comprising the following elements in the following percentages by weight:
20-45% carbon;
0-5% hydrogen;
50-77% fluorine; and
0-20% oxygen;
wherein the copolymer includes at least one of hydrogen or oxygen.

20. A low refractive index layer according to claim 19, said fluorinated copolymer being a fluorinated terpolymer.

21. A low refractive index layer according to claim 15, said fluorinated copolymer being a fluorinated terpolymer selected from the group consisting of:
a) 20% TFE-10% ET-70% VF;
b) 20% TFE-10% HFP-70% VF; and
c) 40% PFV-10% HFP-50% VF; ps wherein all percentages are percentages by weight of the specified monomer in the respective terpolymer.

22. A low refractive index layer according to claim 15, said low refractive index layer being formed by coating a substrate surface with a liquid coating composition comprising non-volatile components, including said fluorinated copolymer, dissolved in a non-halogenated organic solvent, and then permitting or causing the non-halogenated organic solvent to evaporate thereby depositing the non-volatile components onto the substrate surface.

23. A low refractive index layer according to claim 22, said fluorinated copolymer being a fluorinated terpolymer.

24. A low refractive index layer according to claim 15, said fluorinated copolymer being a fluorinated terpolymer.

25. A low refractive index layer according to claim 15, said fluorinated copolymer being soluble in at least one of MEK, MIBK or ethyl acetate.

26. An information display structure comprising a substantially transparent substrate having a surface and an anti-refractive coating on said surface, said anti-refractive coating comprising a low refractive index layer which comprises a fluorinated copolymer of at least three different species of monomeric units, wherein at least one of said species of monomeric units is a fluorinated species, said fluorinated copolymer being soluble in a non-halogenated organic solvent.

27. An information display structure according to claim 26, said substrate being selected from among glass, polyethylene terephthalate, polymethyl methacrylate, polycarbonate and tri-acetate cellulose.

28. An information display structure according to claim 26, said fluorinated copolymer comprising the following elements in the following percentages by weight:
20-45% carbon;
0-5% hydrogen;
50-77% fluorine; and
0-20% oxygen;
wherein the copolymer includes at least one of hydrogen or oxygen.

29. An information display structure according to claim 28, said fluorinated copolymer being a fluorinated terpolymer.

30. An information display structure according to claim 26, said fluorinated copolymer being a fluorinated terpolymer selected from the group consisting of:
a) 20% TFE-10% ET-70% VF;
b) 20% TFE-10% HFP-70% VF; and
c) 40% PFV-10% HFP-50% VF;
wherein all percentages are percentages by weight of the specified monomer in the respective terpolymer.

31. An information display structure comprising a substantially transparent substrate having a surface and an anti-refractive coating on. said surface, said anti-refractive coating comprising a first low refractive index layer and a second low refractive index layer located superjacent the first low refractive index layer and spaced therefrom by at least one high refractive index layer, said first low refractive index layer comprising a first fluorinated copolymer of at least three different species of monomeric units, wherein at least one of said species of monomeric units is a fluorinated species, said first fluorinated copolymer being soluble in a non-halogenated organic solvent,
said second low refractive index layer comprising a second fluorinated copolymer of at least three different species of monomeric units, wherein at least one of said species of monomeric units is a fluorinated species, said second fluorinated copolymer being soluble in a non-halogenated organic solvent,
wherein said first and second fluorinated copolymers are not necessarily the same.

32. An information display structure according to claim 31, wherein said first and second fluorinated copolymers are fluorinated terpolymers, each comprising the following elements in the following percentages by weight:
20-45% carbon;
0-5% hydrogen;
50-77% fluorine; and
0-20% oxygen;
wherein the terpolymer includes at least one of hydrogen or oxygen.

33. An information display structure according to claim 32, said first and second fluorinated copolymers being the same fluorinated terpolymer.

34. A method for depositing a low refractive index layer comprising:
a) preparing or providing a non-volatile mixture comprising a fluorinated copolymer of at least three different species of monomeric units, wherein at least one of said species of monomeric units is a fluorinated species, said fluorinated copolymer being soluble in a non-halogenated organic solvent;
b) dissolving said non-volatile mixture in a non-halogenated organic solvent to provide a coating composition;
c) coating a substrate surface with said coating composition via a wet coating process; and
d) permitting or causing said non-halogenated organic solvent to evaporate thereby depositing the non-volatile mixture onto the substrate surface.

35. A method according to claim 34, said fluorinated copolymer being a fluorinated terpolymer comprising the following elements in the following percentages by weight:
20-45% carbon;
0-5% hydrogen;
50-77% fluorine; and
0-20% oxygen;
wherein the terpolymer includes at least one of hydrogen or oxygen.
